(19) United States
(12) Patent Application Publication
(10) Pub. No.: US 2025/0216355 A1
(43) Pub. Date: Jul. 3, 2025

(54) SENSITIVE MEMBRANE AND GAS SENSOR

(71) Applicant: Panasonic Intellectual Property Management Co., Ltd., Osaka (JP)

(72) Inventors: Atsuo NAKAO, Nara (JP); Yosuke HANAI, Osaka (JP)

(21) Appl. No.: 18/848,710

(22) PCT Filed: Mar. 17, 2023
(86) PCT No.: PCT/JP2023/010580

§ 371 Date: Sep. 19, 2024

(30) Foreign Application Priority Data
Mar. 23, 2022 (JP) 2022-047623

(51) Int. Cl. G01N 27/12

(52) U.S. Cl. CPC G01N 27/125

(57) ABSTRACT

A sensitive membrane contains a sensitive material and conductive particles. The sensitive material adsorbs an analyte. The conductive particles are modified with at least one of alkylsilane or arylsilane.

### TECHNICAL FIELD

The present disclosure generally relates to a sensitive membrane and a gas sensor. More particularly, the present disclosure relates to a sensitive membrane containing a sensitive material and conductive particles and a gas sensor including such a sensitive membrane.

### BACKGROUND ART

Patent Literature 1 discloses a sensor for use in an artificial olfactory system. This sensor detects an analyte in a fluid, includes a layer containing conductive modification particles, and is electrically connected to an electrical measuring device. The conductive modification particles include a carbon black having at least one organic group.

### CITATION LIST

### Patent Literature

Patent Literature 1: JP 2004-510953 A

### SUMMARY OF INVENTION

A sensitive membrane according to an aspect of the present disclosure contains a sensitive material and conductive particles. The sensitive material adsorbs an analyte. The conductive particles are modified with at least one of alkylsilane or arylsilane.

A gas sensor according to another aspect of the present disclosure includes the sensitive membrane described above, and a pair of electrodes electrically connected to the sensitive membrane.

### BRIEF DESCRIPTION OF DRAWINGS

FIG. 1A is a perspective view illustrating a gas sensor according to an exemplary embodiment of the present disclosure;

FIG. 1B is a plan view illustrating a sensor unit of the gas sensor;

FIG. 1C is a perspective view illustrating a sensitive membrane of the gas sensor;

FIGS. 2A and 2B illustrate how the sensitive membrane of the gas sensor may operate in an example;

FIG. 3 is a graph showing how the resistance value may change with time through the operation of the sensitive membrane of the gas sensor;

FIG. 4A is a graph showing, in comparison, the respective sensor sensitivities Rs/R0 of Comparative Example 1 and Examples 1-1 to 1-3;

FIG. 4B is a graph showing, in comparison, the respective resistance values of Comparative Example 1 and Examples 1-1 to 1-3;

FIG. 5 is a graph showing how the resistance value changes with the amount of alkylsilane added to a carbon black in Comparative Example 1 and Examples 1-1 through 4-4;

FIG. 6A is a graph showing how the sensor sensitivity changes with the amount of alkylsilane added to a carbon black in Comparative Example 1, Example 1-1, and Examples 2-1 through 2-4;

FIG. 6B is a graph showing how the SNR changes with the amount of alkylsilane added to a carbon black in Comparative Example 1, Example 1-1, and Examples 2-1 through 2-4;

FIG. 7A is a graph showing how the sensor sensitivity changes with the surface coverage of a carbon black in Comparative Example 1, Example 1-1, and Examples 2-1 through 2-4;

FIG. 7B is a graph showing how the SNR changes with the surface coverage of a carbon black in Comparative Example 1, Example 1-1, and Examples 2-1 through 2-4;

FIG. 8A is a graph showing how the sensor sensitivity changes with the amount of alkylsilane added to a carbon black in Comparative Example 1, Example 1-2, and Examples 3-1 through 3-4;

FIG. 8B is a graph showing how the SNR changes with the amount of alkylsilane added to a carbon black in Comparative Example 1, Example 1-2, and Examples 3-1 through 3-4;

FIG. 9A is a graph showing how the sensor sensitivity changes with the surface coverage of a carbon black in Comparative Example 1, Example 1-2, and Examples 3-1 through 3-4;

FIG. 9B is a graph showing how the SNR changes with the surface coverage of a carbon black in Comparative Example 1, Example 1-2, and Examples 3-1 through 3-4;

FIG. 10A is a graph showing how the sensor sensitivity changes with the amount of alkylsilane added to a carbon black in Comparative Example 1, Example 1-3, and Examples 4-1 through 4-4;

FIG. 10B is a graph showing how the SNR changes with the amount of alkylsilane added to a carbon black in Comparative Example 1, Example 1-3, and Examples 4-1 through 4-4;

FIG. 11A is a graph showing how the sensor sensitivity changes with the surface coverage of a carbon black in Comparative Example 1, Example 1-3, and Examples 4-1 through 4-4;

FIG. 11B is a graph showing how the SNR changes with the surface coverage of a carbon black in Comparative Example 1, Example 1-3, and Examples 4-1 through 4-4;

FIG. 12A is a graph showing how the sensitivity Rs/R0 changes according to the coverage for each type of silane coupling agent in Comparative Example 1 and Examples 1-1 through 4-4;

FIG. 12B is a graph showing how the SNR changes according to the coverage for each type of silane coupling agent in Comparative Example 1 and Examples 1-1 through 4-4;

FIG. 13A is a transmission electron micrograph showing a cross section of a sensitive membrane according to Example 1-1;

FIG. 13B is a transmission electron micrograph showing a cross section of a sensitive membrane according to Example 1-2; and

FIG. 13C is a transmission electron micrograph showing a cross section of a sensitive membrane according to Comparative Example 1.

### DESCRIPTION OF EMBODIMENTS

### 1. Overview

First, it will be described how the present inventors conceived the concept of a sensitive membrane and gas sensor according to the present disclosure.

A sensor has been known in the art which uses the chemical adsorption and desorption of an analyte (such as a gas) into/out of a membrane made of a resin component to learn about, for example, the condition of the surrounding air such as a sensor for use in an artificial olfactory system. It has been proposed to add, for example, inorganic particles to the resin component of the sensor to change the ability of the resin component to adsorb and desorb the analyte. Patent Literature 1 expects to improve the adsorptivity of the analyte by adding conductive modification particles including a carbon product with an organic group bonded thereto.

However, the present inventors discovered, as a result of our unique research, that it would be difficult to improve the sensitivity simply by adding conductive modification particles as is done in Patent Literature 1. Thus, to provide a sensitive membrane that would further improve the sensitivity, the present inventors carried out extensive research to conceive the concept of a sensitive membrane and gas sensor according to the present disclosure.

A sensitive membrane 20 according to an exemplary embodiment contains a sensitive material and conductive particles 202 modified with at least one of alkylsilane or arylsilane. It is not completely clear why the sensitive membrane 20 according to this embodiment achieves high sensitivity in a gas sensor 1 but the reason is presumably as follows:

Modifying unmodified conductive particles with at least one of alkylsilane or arylsilane allows the inter-particle distance to be moderately extended compared to unmodified conductive particles, thus causing an increase in an electrical resistance value (hereinafter simply referred to as a “resistance value”). In addition, modifying unmodified conductive particles with at least one of alkylsilane or arylsilane may also enhance the interaction between the sensitive material 201 and the conductive particles 202 compared to unmodified conductive particles. Thus, the adsorption and desorption of the analyte into/out of the sensitive material 201 would make the inter-particle distance of the conductive particles 202 more easily changeable, which would cause an increase in the sensitivity of the sensitive membrane 20 according to this embodiment. Note that the principle of measuring a variation in resistance value in, for example, a sensor including the sensitive membrane 20 will be described later.

As can be seen, the sensitive membrane 20 according to this embodiment may be used in a sensor and contributes to improving the sensitivity of the sensor, thus enabling providing a high-sensitivity gas sensor 1 such as a gas sensor 1 for olfactory detection, among other things.

### 2. Details

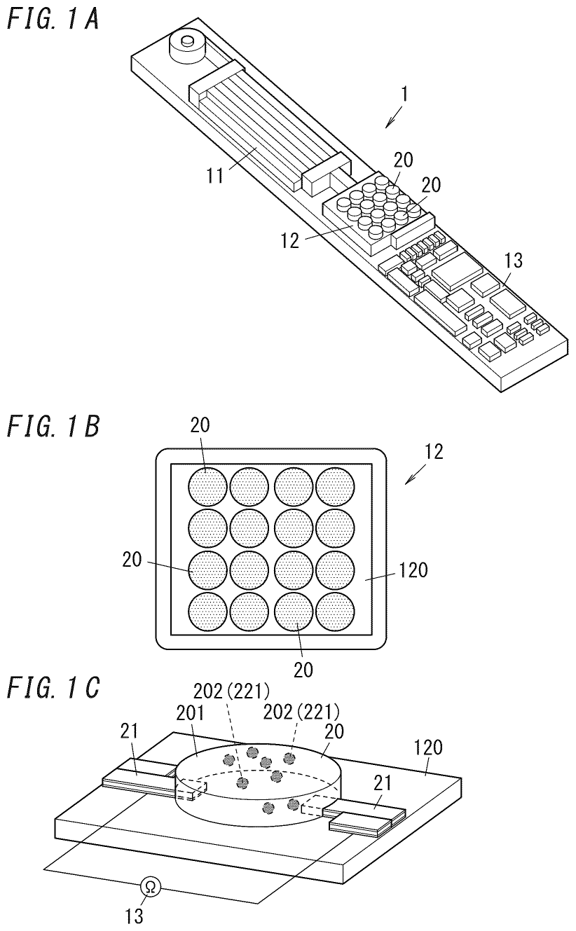

Specific configurations for a gas sensor 1 and sensitive membrane 20 according to the present disclosure will now be described in detail. First, a configuration for the gas sensor 1 will be described with reference to the accompanying drawings (namely, FIGS. 1A-3).

### [Gas Sensor]

A gas sensor 1 according to this embodiment includes the sensitive membrane 20, and a pair of electrodes electrically connected to the sensitive membrane 20. The sensitive membrane 20 contains a sensitive material and conductive particles 202 modified with at least one of alkylsilane or arylsilane as described above. A preferred configuration for the sensitive membrane will be described in detail later.

FIG. 1A illustrates a schematic configuration for the gas sensor 1 according to this embodiment. The gas sensor 1 may be used to, for example, detect molecules included in a gas. Examples of the detection targets include molecules of: combustible gases such as methane, propane, and butane; poisonous gases such as ammonia, hydrogen sulfide, and carbon monoxide; and volatile organic compounds (VOCs). However, these are only exemplary detection target molecules and should not be construed as limiting. The detection target may include a substance that stimulates the human olfactory sense (i.e., so-called “odor components”). The gas sensor 1 may detects VOCs included in a sample gas such as a gas taken from a food, a breath taken from a human body, or the air taken from a building room.

As shown in FIG. 1A, the gas sensor 1 includes a supply unit 11, a sensor unit 12, and a processing unit 13. The supply unit 11 supplies a sample gas and a reference gas to the sensor unit 12. The sample gas as used herein refers to a gas including either a single molecule or a plurality of molecules as detection target, e.g., a gas including the odor molecules described above. The reference gas as used herein may include an inert gas such as nitrogen gas, oxygen gas, and helium gas. The reference gas may also be an odorless gas.

In FIG. 1A, the sensor unit 12 includes a plurality of sensitive membranes 20 and a plurality of electrodes 21. The processing unit 13 includes a detection unit (not shown) for detecting a variation in the resistance value measured by the sensor unit 12, for example, and a control unit (not shown) for controlling the operation of the gas sensor 1. The supply unit 11 includes piping through which the sample gas and the reference gas, for example, circulate. The processing unit 13 includes electric circuits serving as the detection unit and the control unit. Note that the gas sensor 1 has only to include the sensor unit 12 and the supply unit 11 and the processing unit 13 are not essential constituent elements for the gas sensor 1.

As shown in FIG. 1B, the sensor unit 12 is formed by providing a plurality of sensitive membranes 20 on a substrate 120. A number of sensitive membranes 20 are arranged vertically and horizontally to form an array (e.g., a 4×4 array in FIGS. 1A and 1B) of sensitive membranes 20 on the substrate 120. Each of these sensitive membranes 20 is formed in a circular pattern in plan view. Note that the number, arrangement, and shape of the sensitive membranes 20 in the sensor unit 12 do not have to be the ones shown in FIG. 1B but may also be changed as appropriate according to the type of the gas sensor 1, for example.

As shown in FIG. 1C, each sensitive membrane 20 includes a sensitive material 201 that adsorbs the detection target and conductive particles 202. The conductive particles 202 are dispersed in the matrix of the sensitivity material 201.

A pair of electrodes 21 are connected to the sensitive membrane 20. Each of these electrodes 21 is electrically connected to the conductive particles 202 in the sensitive membrane 20. If the gas sensor 1 includes the processing unit 13, the pair of electrodes 21 are preferably electrically connected to the detection unit of the processing unit 13.

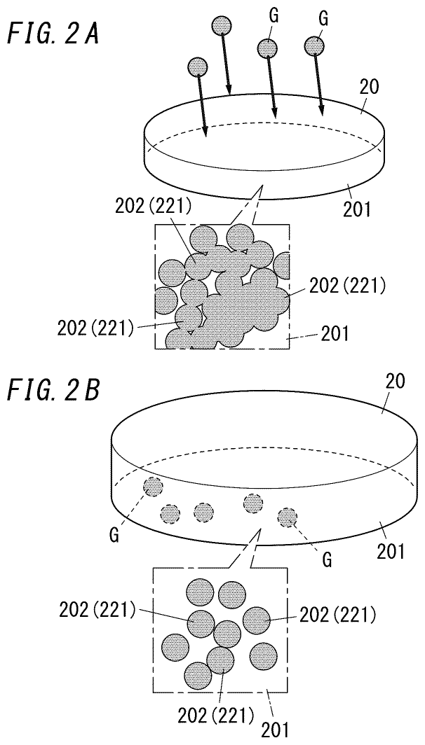

Before such a sensitive membrane 20 adsorbs detection target molecules G, the gap between the plurality of conductive particles 202 dispersed in the sensitive material 201 is relatively narrow as shown in FIG. 2A, for example. Once the sensitive membrane 20 has adsorbed the molecules G, the sensitive material 201 expands to widen the gap between the conductive particles 202 (refer to FIGS. 2A and 2B).

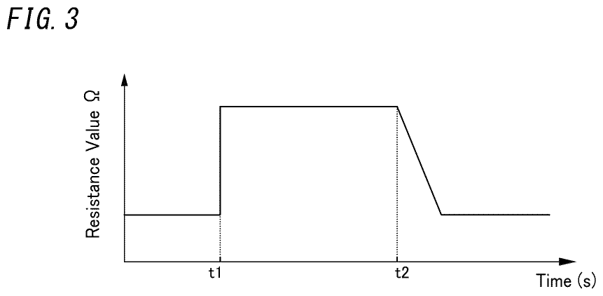

As a result, as the sensitive membrane 20 adsorbs the molecules G, the sensitive material 201 expands to have an increased thickness and comes to have an increased resistance value at a time t1 of adsorption as shown in FIG. 3. Meanwhile, as the molecules G desorb from the sensitive membrane 20, the sensitive material 201 begins to shrink and gradually recovers its original shape. As a result, the resistance value starts to decrease gradually at a time t2 of desorption of the molecules G. Consequently, the gas sensor 1 may determine, by making the detection unit of the processing unit 13, which is electrically connected to the electrodes 21, detect this change in the resistance value, whether there are any molecules G in the sample gas supplied from the supply unit 11 to the sensor unit 12. Note that FIGS. 2A and 2B are only schematic representations illustrating, as an example, how the sensitive membrane 20 of the gas sensor 1 may operate and should not be construed as limiting the dimensions, shape, and state of the sensitive membrane 20. In this embodiment, the conductive particles 202 dispersed in the sensitive material 201 of the sensitive membrane 20 are modified with at least one of alkylsilane or arylsilane. That is why the adsorption of the molecules G into the sensitive membrane 20 may cause an increase in resistance value, thus enabling further improving the sensitivity when detecting the detection target.

Next, a preferred configuration for a sensitive membrane according to this embodiment will be described.

### [Sensitive Membrane]

The sensitive membrane 20 according to this embodiment contains the sensitive material 201 and the conductive particles 202, as described above. Specifically, the sensitive membrane 20 contains the sensitive material 201, and the conductive particles 202 are dispersed in the sensitive material 201.

### (Sensitive Material)

The sensitive material 201 according to this embodiment is a component which may adsorb the analyte. In this embodiment, the sensitive material 201 is a material which may expand when adsorbing the analyte. Thus, the sensitive material 201 may impart good sensor capability to the sensitive membrane 20. Specifically, the sensitive material 201 makes a variation in resistance value more easily detectible based on the expansion of the sensitive material 201 that has adsorbed the analyte. Therefore, applying the sensitive material 201 to the sensitive membrane 20 electrically connected to the electrodes 21 makes it easier to detect the analyte based on a variation in resistance value.

The sensitive material 201 may be selected according to, for example, the type of the chemical substance to adsorb and the type of the conductive particles 202. The sensitive material 201 is made of an organic material with electrical insulation properties and includes at least one material selected from the group consisting of high molecular (macromolecular) materials and low molecular materials, for example. Among other things, the sensitive material 201 preferably includes a high molecular material. Adding a high molecular material to the sensitive material 201 may impart heat resistance to the sensitive membrane 20.

It is more preferable that the sensitive material 201 contain a compound having either or both of a polysiloxane structure and/or a polyethylene glycol structure. This may improve the adsorption/desorption capability of the sensitive membrane 20 particularly significantly. As used herein, the “polysiloxane structure” refers to a structure having an —Si—O—Si— structural unit in a molecule. The “polyethylene glycol structure” as used herein refers to a structure having an —O—CH₂CH₂— structural unit in a molecule. The sensitive material 201 may naturally have both the polysiloxane structure and the polyethylene glycol structure. Examples of such compounds having both the polysiloxane structure and the polyethylene glycol structure include polysiloxane-polyethylene glycol copolymers.

Examples of the sensitive material 201 include materials commercially available as stationary phases for columns in gas chromatographs. More specifically, the sensitive material preferably includes, for example, at least one material selected from the group consisting of polysiloxanes, polyalkylene glycols, polyesters, silicones, glycerols, nitriles, dicarboxylic acid monoesters, and aliphatic amines. This allows the sensitive material 201 to easily adsorb chemical substances (volatile organic compounds, in particular) in a gas such as the sample gas.

The polysiloxanes may include at least one material selected from the group consisting of, for example, dimethyl silicone, phenylmethyl silicone, trifluoropropyl methyl silicone, and cyano silicone (with a heat resistant temperature of 275° C.).

The polyalkylene glycols include, for example, polyethylene glycol (with a heat resistant temperature of 170° C.). The polyesters include, for example, at least one material selected from the group consisting of poly(diethylene glycol adipate) and poly(ethylene succinate).

The glycerols include, for example, diglycerol (with a heat resistant temperature of 150° C.). The nitriles include at least one material selected from the group consisting of, for example, N, N-bis(2-cyanoethyl) formamide (with a heat resistant temperature of 125° C.) and 1, 2, 3-tris (2-cyanoethoxy) propane (with a heat resistant temperature of 150° C.).

The dicarboxylic acid monoesters include at least one material selected from the group consisting of, for example, nitro terephthalic acid-modified polyethylene glycol (with a heat resistant temperature of 275° C.) and diethylene glycol succinate (with a heat resistant temperature of 225° C.).

The aliphatic amines include, for example, tetra hydroxyethyl ethylenediamine (with a heat resistant temperature of 125° C.).

### (Conductive Particles)

The conductive particles 202 may be dispersed in the sensitive material 201 in the sensitive membrane 20 as described above. The conductive particles 202 according to this embodiment are modified with at least one of alkylsilane or arylsilane. Thus, an interfacial layer which covers the conductive particles 202 may be formed by at least one of alkylsilane or arylsilane.

The mean particle size of the conductive particles 202 is preferably equal to or greater than 10 nm and equal to or less than 100 nm. Setting the mean particle size at a value equal to or greater than 10 nm makes it easier to avoid causing an increase in the resistance value detected by the sensitive membrane 20. Setting the mean particle size at a value equal to or less than 100 nm makes it easier for the presence of the interfacial layer covering the conductive particles 202 in the sensitive membrane 20 to keep contributing to improving the sensitivity significantly. The mean particle size of the conductive particles 202 is more preferably equal to or greater than 10 nm and equal to or less than 50 nm. Note that as used herein, the mean particle size of the conductive particles refers to the mean particle size of unmodified conductive particles and means a number-average size of particle sizes measured by electron microscopy. Specifically, a sample is prepared by either subjecting the sensitive membrane 20 to machining to expose a cross section of the membrane or dispersing a part of the sensitive membrane 20 in an organic solvent and then fixing that part to a supporting member (such as a supporting film). Subsequently, a photograph of the sample is shot with a transmission electron microscope, for example, to calculate the particle size based on the diameter on the photograph and the zoom power of the photograph. The number of particles when the particle size is calculated as an arithmetic mean is preferably equal to or greater than 100 and may be, for example, 1500.

The conductive particles 202 preferably contain a carbon black. This allows the electrical conductivity in the sensitive membrane 20 to be maintained at a sufficiently high value. The carbon black is an aggregate of ultrafine spherical particles formed through incomplete combustion of either hydrocarbon or a compound including carbon.

Optionally, the sensitive membrane 20 may contain an electrically conductive component other than the conductive particles modified with alkylsilane or arylsilane. The electrically conductive component may include at least one material selected from the group consisting of, for example, conductive polymers, metals, metal oxides, semiconductors, superconductors, and complex compounds.

The alkylsilane only needs to have a structure in which an alkyl group is bonded to a silicon atom, and includes, for example, a silane compound having a structure derived from a silane coupling agent having an alkyl group. The alkylsilane preferably contains a compound having an alkyl group, of which the carbon number is equal to or greater than one and equal to or less than three. This may further improve the sensitivity of the sensitive membrane 20. It is particularly preferable that the alkylsilane contain a compound having a methyl group. This makes it easier to further improve the sensitivity of the sensitive membrane 20. The conductive particles 202 in the sensitive membrane 20 do not have to include only one type of alkylsilane but may also include multiple types of alkylsilanes. That is to say, the conductive particles 202 may be modified with two or more alkylsilanes having different structures or may include multiple types of conductive particles 202 modified with alkylsilanes having mutually different structures. Therefore, the alkylsilane modifying the conductive particles 202 may include at least one substituent selected from the group consisting of a methyl group, an ethyl group, and a propyl group.

It is preferable that the alkylsilane contain a compound having an alkoxy group. In that case, the alkylsilane has a structure in which at least one alkoxy group is bonded to a silicon atom. More preferably, the alkylsilane contains a compound having three alkoxy groups. Adding a compound having an alkoxy group to the alkylsilane enables further improving the sensitivity of the sensitive membrane 20.

The alkylsilane may include, for example, a compound having not only an alkyl group, of which the carbon number is equal to or greater than one and equal to or less than three, but also an alkoxy group as well. Specifically, the alkylsilane includes at least one compound selected from the group consisting of alkylalkoxysilane, alkyldialkoxysilane, alkyltrialkoxysilane, dialkylalkoxysilane, dialkyldialkoxysilane, and trialkylalkoxysilane.

The arylsilane only needs to have a structure in which an aryl group is bonded to a silicon atom, and includes, for example, a silane compound having a structure derived from a silane coupling agent having an aryl group. It is preferable that the arylsilane contain a compound having, for example, a phenyl group. The phenyl group may be unsubstituted, or a hydrogen atom on the phenyl group may be replaced with another substituent. This allows the distance between the conductive particles 202 to be kept moderately short without being too long. This may further improve the sensitivity of the sensitive membrane 20.

It is preferable that the arylsilane contain a compound having an alkoxy group. In this case, the arylsilane has a structure in which an aryl group and at least one alkoxy group are bonded to a silicon atom. Adding a compound having an alkoxy group to the arylsilane may further improve the sensitivity of the sensitive membrane 20. More preferably, the arylsilane contains a compound having three alkoxy groups.

As the alkylsilane and arylsilane, appropriate silane compounds may be used. For example, compounds known as silane coupling agents may be used. Examples of the silane coupling agent include methyltrimethoxysilane, dimethyldimethoxysilane, methyltriethoxysilane, dimethyldiethoxysilane, n-propyltrimethoxysilane, n-propyltriethoxysilane, hexyltrimethoxy-silane, hexyltriethoxysilane, octyltriethoxysilane, decyltriethoxysilane, 1,6-bis(triethoxysilyl) hexane, 3,3,3-trifluoropropyltrimethoxysilane, phenyltrimethoxysilane, diphenyldimethoxysilane, phenyltriethoxysilane, and diphenyl diethoxysilane.

In this embodiment, the conductive particles 202 may be modified with at least one of alkylsilane or arylsilane by the following method, for example.

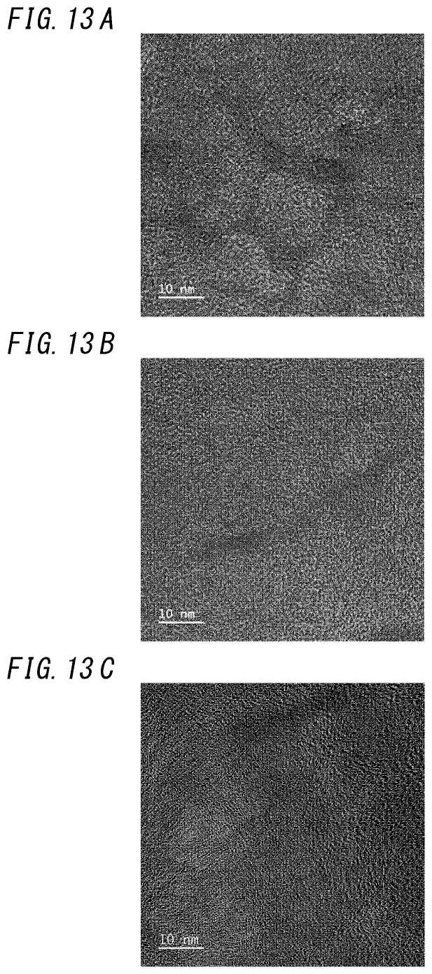

Unmodified conductive particles, a silane coupling agent as a silane compound, and appropriate additives as needed were provided, mixed together in a solvent, and homogenized while being stirred up using a ball mill. In this case, conditions such as temperature, pressure, and atmosphere may be adjusted as appropriate. For example, these materials may be mixed together at an ordinary temperature, under a normal pressure, and in the air. This allows the conductive particles 202 to be modified. It may be confirmed, based on an image shot with a transmission electron microscope (TEM), that the conductive particles 202 are modified. FIGS. 13A to 13C show images shot with a TEM of the gas sensor 1 including the sensitive membrane 20 as an example. In this embodiment, an interfacial layer is observed on the surface of the conductive particles 202 in FIGS. 13A and 13B, while no interfacial layer is observed in FIG. 13C. Thus, it may be determined that the conductive particles shown in FIGS. 13A and 13B are modified with at least one of alkylsilane and arylsilane.

The proportion of alkylsilane added, i.e., the proportion by weight of the alkylsilane to the total weight of conductive particles 202, when unmodified conductive particles are modified with the alkylsilane, is preferably equal to or greater than 10% by weight. This makes it easier to improve the sensitivity of the sensitive membrane 20. The proportion by weight of the alkylsilane to the total weight of the conductive particles 202 is more preferably equal to or greater than 10% by weight and equal to or less than 40% by weight. This makes it particularly easy to improve the sensitivity of the sensitive membrane 20. As used herein, the “total weight of conductive particles” refers to the weight of conductive particles in an unmodified state. The proportion of arylsilane added, i.e., the proportion by weight of the arylsilane to the total weight of conductive particles 202, when unmodified conductive particles are modified with the arylsilane, is preferably equal to or greater than 10% by weight. This makes it easier to improve the sensitivity of the sensitive membrane 20. The proportion by weight of the arylsilane to the total weight of the conductive particles 202 is more preferably equal to or greater than 10% by weight and equal to or less than 40% by weight. This makes it particularly easy to improve the sensitivity of the sensitive membrane 20.

The coverage at which the conductive particles 202 are covered with alkylsilane is preferably equal to or higher than 10%. This may further improve the sensitivity of the sensitive membrane 20. The coverage is more preferably equal to or higher than 12% and equal to or lower than 55%. This may not only improve the sensitivity of the sensitive membrane 20 but also increase the SNR of the sensor sensitivity as well. Therefore, setting the coverage at a value equal to or higher than 10% allows the sensitive membrane 20 to stably detect the analyte with high sensitivity. Note that the SNR will be described later. The coverage is more preferably equal to or higher than 27% and equal to or lower than 47%. According to the present disclosure, the coverage may be calculated as follows:

The minimum covered surface area S₁ [m²/g], representing the surface area of a monomolecular layer which may be covered with 1 g of alkylsilane, is calculated by the following equation (1):

$${S}_{1} = ( 6.02 \times {10}^{23} \times 13 \times {10}^{- 20} ) / ( molecular weight of alkylsilane ) \qquad ( 1 )$$

If the reaction rate is r, the amount of alkylsilane added is m₁ [g], the mass of the particles to be covered is m₀ [g], and the specific surface area of the particles to be covered is so [m₂/g], the coverage may be calculated, based on these parameters and the minimum covered surface area S₁ [m²/g] calculated as described above, by the following equation (2):

$$Coverage [ \% ] = r \times ( {m}_{1} \times {S}_{1} ) / ( {m}_{0} \times {s}_{0} ) \times 100 \qquad ( 2 )$$

The coverage at which the conductive particles 202 are covered with arylsilane is preferably equal to or higher than 10%. This may further improve the sensitivity of the sensitive membrane 20. The coverage is preferably equal to or higher than 10% and equal to or lower than 41%. This may not only improve the sensitivity of the sensitive membrane 20 but also increase the SNR of the sensor sensitivity as well. This allows the sensitive membrane 20 to stably detect the analyte with high sensitivity. The coverage according to the present disclosure may be calculated by calculating Si with “molecular weight of alkylsilane” in the equation (1) replaced with “molecular weight of arylsilane” and with “the amount of alkylsilane added” in the equation (2) replaced with “the amount of arylsilane added.”

The specific surface area of the conductive particles is preferably equal to or greater than 100 m³/g and equal to or less than 500 m³/g. Setting the specific surface area of the conductive particles at a value falling within this range makes it easier to modify the conductive particles 202 with either alkylsilane or arylsilane. The specific surface area of the conductive particles may be obtained by making measurement on unmodified conductive particles by the method compliant with the JIS K6217-2:2017 standard.

The sensor sensitivity of the gas sensor 1 according to this embodiment may be defined as Rs/R0, where Rs is the resistance value measured on the sensitive membrane 20 when a sample gas to be evaluated by the gas sensor 1 is introduced and R0 is the resistance value measured on the sensitive membrane 20 when a reference gas is introduced into the gas sensor 1. In the following description, the sensor sensitivity will be hereinafter sometimes referred to as “Rs/R0.” Rs/R0 is measured by the method to be described later with respect to Examples. Note that the reference gas according to this embodiment is nitrogen gas, and the sample gas contains benzaldehyde and pyrrole each having volatility. These sample gases are only examples and should not be construed as limiting.

It is preferable that the SNR of the sensor sensitivity in the gas sensor 1 be equal to or greater than 3000, for example, with respect to a plurality of sample gases. In that case, compared to a situation where the gas sensor 1 has a normal detection limit (e.g., an SNR of about 3), the concentration of the sample gas will be, for example, about 1000 times as high as the sample gas concentration to be described below for Examples. This enables recognizing the type or components of even a volatile gas with a very low concentration. According to the present disclosure, the SNR may be calculated by dividing the sensor sensitivity Rs/R0 by the standard deviation σ_{R0} of R0. The standard deviation σ_{R0} may be calculated based on the resistance value R0 at a point in time when the 100^{th} sample was taken during a period from −0.1 seconds through 1.1 seconds on the supposition that 0 seconds was a point in time when a nitrogen gas was introduced as a reference gas into the gas sensor 1 and started to flow in. Specifically, the SNR may be measured and calculated by the method to be described later for Examples.

The sensitive membrane 20 may be formed, for example, in the following manner. A mixture is prepared by adding the components which may be included in the sensitive membrane 20 described above, the sensitive material, the conductive particles subjected to the modification treatment, and as needed, appropriate additives to the solvent. Then, the mixture is stirred up and homogenized. Optionally, in this case, the constituent components may be mixed to be sufficiently homogenized using a mixer or a blender, for example, subsequently kneaded with a kneading machine such as a hot roll or kneader while being heated, and then cooled. To stir up the mixture, for example, a disper, a planetary mixer, a ball mill, a three-roll mill, a bead mill, and other stirrers may be used in an appropriate combination, as needed. A sensitive membrane may be formed by applying the mixture to a suitable base member, for example, to form a coating film and then drying, or heating and drying as needed, the coating film. The mixture may be applied by any appropriate method, which may be, for example, a doctor blade method or an inkjet method.

A sensitive membrane may also be formed by applying the mixture onto a base member and a pair of electrodes and then drying the mixture thus applied. A gas sensor 1 may be produced by subjecting the sensitive membrane thus formed to heating treatment at 85° C., for example, after that.

### EXAMPLES

Next, specific examples of the present disclosure will be presented. Note that the examples to be described below are only examples of the present disclosure and should not be construed as limiting.

1. Preparation of Materials for Sensitive Membrane and then Making Test Piece

### Examples 1-1 to 1-3 and Comparative Example 1

### Comparative Example 1

A carbon black powder (product name #2300 manufactured by Mitsubishi Chemical Corporation, having a mean particle size of 15 nm and a specific surface area of 320 m²/g) was provided as unmodified conductive particles. Next, 1.6 g of the carbon black powder was added to 40 mL of a solvent (NMP: N-methyl-2-pyrrolidone). Then, the mixture was stirred up and homogenized using a ball mill under the condition including room temperature (of about 25° C.) and a normal pressure in the air.

Next, a polysiloxane compound (polysiloxane-polyethylene glycol copolymer, product name OV-330 manufactured by Shinwa Chemical Industries Ltd.) was added as a sensitive material to the mixture including the solvent such that the content of the polysiloxane compound added was 50% by weight with respect to the weight of the carbon black. Thereafter, the resultant mixture was further subjected to ultrasonic treatment at room temperature (of about 25° C.) to be further homogenized. In this manner, a material for forming a sensitive membrane (hereinafter simply referred to as a “sensitive membrane material”) was prepared.

Next, an electrode chip having abase member and a pair of electrodes on the base member was provided, and the sensitive membrane material was applied onto the electrode chip to cover the base member and the pair of electrodes, thereby forming a coating film of the sensitive membrane material. This coating film was dried at 50° C. for 20 minutes. The coating film thus dried was further heated at 85° C. for 12 hours. In this manner, a test piece of a gas sensor including a sensitive membrane on the base member and electrodes was obtained. The conductive particles in the sensitive membrane were electrically connected to a pair of electrodes of the gas sensor. In addition, a detector for measuring a resistance value was electrically connected to the pair of electrodes of the gas sensor.

### Example 1-1

A carbon black powder (product name #2300 manufactured by Mitsubishi Chemical Corporation, having a mean particle size of 15 nm and a specific surface area 320 m²/g) was provided as unmodified conductive particles, and methyltriethoxysilane (manufactured by Tokyo Chemical Industry Co., Ltd., having a molecular weight 178.3) as a silane coupling agent was provided as the alkylsilane. Next, 1.6 g of the carbon black powder and methyltriethoxysilane (20% by weight with respect to the weight of the carbon black) were added to 40 mL of solvent (NMP: N-methyl-2-pyrrolidone). Then, the mixture was stirred up and homogenized using a ball mill under the condition including room temperature (of about 25° C.) and a normal pressure in the air. As a result, conductive particles modified with alkylsilane were obtained. The coverage of the conductive particles is calculated to be 27.4% by equations (1) and (2). In this case, the calculation was made with the reaction rate supposed to be 1.0. The same statement will apply to Examples 1-2 to 4-4 to be described below. Note that if the coverage is calculated to be greater than 100%, then the coverage is regarded as 100%. The conductive particles thus obtained were observed through a TEM. An image shot through the TEM is shown in FIG. 13A. It was confirmed, by comparing the image thus shot with the image of the unmodified conductive particles of Comparative Example 1-1 (refer to FIG. 13C), that an interfacial layer had been formed. As a result, it was confirmed that the particles were modified with methylsilane (methyltriethoxysilane).

Subsequently, a polysiloxane compound (polysiloxane-polyethylene glycol copolymer, product name OV-330 manufactured by Shinwa Chemical Industries Ltd.) was added as a sensitive material to the mixture including the solvent such that the content of the polysiloxane compound added was 50% by weight with respect to the weight of the carbon black. Thereafter, the resultant mixture was further subjected to ultrasonic treatment at room temperature (of about 25° C.) to be further homogenized. In this manner, a sensitive membrane material was prepared to form a sensitive membrane.

Next, a base member and an electrode chip having a pair of electrodes on the base member were provided, and the sensitive membrane material was applied onto the electrode chip to cover the base member and the pair of electrodes, thereby forming a coating film of sensitive membrane material. This coating film was dried at 50° C. for 20 minutes. The coating film thus dried was further heated at 85° C. for 12 hours. In this manner, a test piece of a gas sensor including a sensitive membrane on the base member and electrodes was obtained. The conductive particles of the sensitive membrane were electrically connected to a pair of electrodes of the gas sensor. In addition, a detector for measuring the resistance value was electrically connected to the pair of electrodes of the gas sensor.

### Example 1-2

Conductive particles modified with alkylsilane and a sensitive membrane material were prepared and a gas sensor was produced in the same way as in Example 1-1 except that the silane coupling agent was changed into propyltriethoxysilane (manufactured by Tokyo Chemical Industry Co., Ltd., having a molecular weight of 206.4). The coverage of the conductive particles which was calculated by the same method as in Example 1-1 was 23.7%. The conductive particles thus obtained were observed through a TEM. An image shot through the TEM is shown in FIG. 13B. It was confirmed, by comparing the image thus shot with the image of the unmodified conductive particles of Comparative Example 1-1 (refer to FIG. 13C), that an interfacial layer had been formed. As a result, it was confirmed that the particles were modified with propylsilane (propyltriethoxysilane).

### Example 1-3

Conductive particles modified with arylsilane and a sensitive membrane material were prepared and a gas sensor was produced in the same way as in Example 1-1 except that the silane coupling agent of Example 1-1 was changed into phenyltriethoxysilane (manufactured by Tokyo Chemical Industry Co., Ltd., having a molecular weight of 240.4). The coverage of the conductive particles which was calculated by the same method as in Example 1-1 was 20.3%. The conductive particles thus obtained were observed through a TEM. It was also confirmed, as in Examples 1-1 and 1-2, that an interfacial layer had been formed. As a result, it was confirmed that the particles were modified with phenylsilane (phenyltriethoxysilane).

### Examples 2-1 to 2-4

### Example 2-1

Conductive particles modified with alkylsilane and a sensitive membrane material were prepared and a gas sensor was produced in the same way as in Example 1-1 except that the content of the methyltriethoxysilane of Example 1-1 was changed into 10% by weight with respect to the weight of the carbon black. The coverage of the conductive particles which was calculated by the same method as in Example 1-1 was 13.7%.

### Example 2-2

Conductive particles modified with alkylsilane and a sensitive membrane material were prepared and a gas sensor was produced in the same way as in Example 1-1 except that the content of the methyltriethoxysilane of Example 1-1 was changed into 40% by weight with respect to the weight of the carbon black. The coverage of the conductive particles which was calculated by the same method as in Example 1-1 was 54.9%.

### Example 2-3

Conductive particles modified with alkylsilane and a sensitive membrane material were prepared and a gas sensor was produced in the same way as in Example 1-1 except that the content of the methyltriethoxysilane of Example 1-1 was changed into 60% by weight with respect to the weight of the carbon black. The coverage of the conductive particles which was calculated by the same method as in Example 1-1 was 82.3%.

### Example 2-4

Conductive particles modified with alkylsilane and a sensitive membrane material were prepared and a gas sensor was produced in the same way as in Example 1-1 except that the content of the methyltriethoxysilane of Example 1-1 was changed into 80% by weight with respect to the weight of the carbon black. The coverage of the conductive particles which was calculated by the same method as in Example 1-1 was 100%.

### Examples 3-1 to 3-4

### Example 3-1

Conductive particles modified with alkylsilane and a sensitive membrane material were prepared and a gas sensor was produced in the same way as in Example 1-1 except that the content of the propyltriethoxysilane of Example 1-2 was changed into 10% by weight with respect to the weight of the carbon black. The coverage of the conductive particles which was calculated by the same method as in Example 1-1 was 11.8%.

### Example 3-2

Conductive particles modified with alkylsilane and a sensitive membrane material were prepared and a gas sensor was produced in the same way as in Example 1-1 except that the content of the propyltriethoxysilane of Example 1-2 was changed into 40% by weight with respect to the weight of the carbon black. The coverage of the conductive particles which was calculated by the same method as in Example 1-1 was 47.4%.

### Example 3-3

Conductive particles modified with alkylsilane and a sensitive membrane material were prepared and a gas sensor was produced in the same way as in Example 1-1 except that the content of the propyltriethoxysilane of Example 1-2 was changed into 60% by weight with respect to the weight of the carbon black. The coverage of the conductive particles which was calculated by the same method as in Example 1-1 was 71.1%.

### Example 3-4

Conductive particles modified with alkylsilane and a sensitive membrane material were prepared and a gas sensor was produced in the same way as in Example 1-1 except that the content of the propyltriethoxysilane of Example 1-2 was changed into 80% by weight with respect to the weight of the carbon black. The coverage of the conductive particles which was calculated by the same method as in Example 1-1 was 94.8%.

### Examples 4-1 to 4-4

### Example 4-1

Conductive particles modified with arylsilane and a sensitive membrane material were prepared and a gas sensor was produced in the same way as in Example 1-1 except that the content of the phenyltriethoxysilane of Example 1-3 was changed into 10% by weight with respect to the weight of the carbon black. The coverage of the conductive particles which was calculated by the same method as in Example 1-1 was 10.2%.

### Example 4-2

Conductive particles modified with arylsilane and a sensitive membrane material were prepared and a gas sensor was produced in the same way as in Example 1-1 except that the content of the phenyltriethoxysilane of Example 1-3 was changed into 40% by weight with respect to the weight of the carbon black. The coverage of the conductive particles which was calculated by the same method as in Example 1-1 was 40.7%.

### Example 4-3

Conductive particles modified with arylsilane and a sensitive membrane material were prepared and a gas sensor was produced in the same way as in Example 1-1 except that the content of the phenyltriethoxysilane of Example 1-3 was changed into 60% by weight with respect to the weight of the carbon black. The coverage of the conductive particles which was calculated by the same method as in Example 1-1 was 61.0%.

### Example 4-4

Conductive particles modified with arylsilane and a sensitive membrane material were prepared and a gas sensor was produced in the same way as in Example 1-1 except that the content of the phenyltriethoxysilane of Example 1-3 was changed into 80% by weight with respect to the weight of the carbon black. The coverage of the conductive particles which was calculated by the same method as in Example 1-1 was 81.4%.

Note that in Examples 2-1 to 4-4, it was also confirmed, based on an image shot through a TEM as in Examples 1-1 and 1-2, that the conductive particles had been modified with alkylsilane.

### 2. Evaluations

### 2.1 Sensor Sensitivity

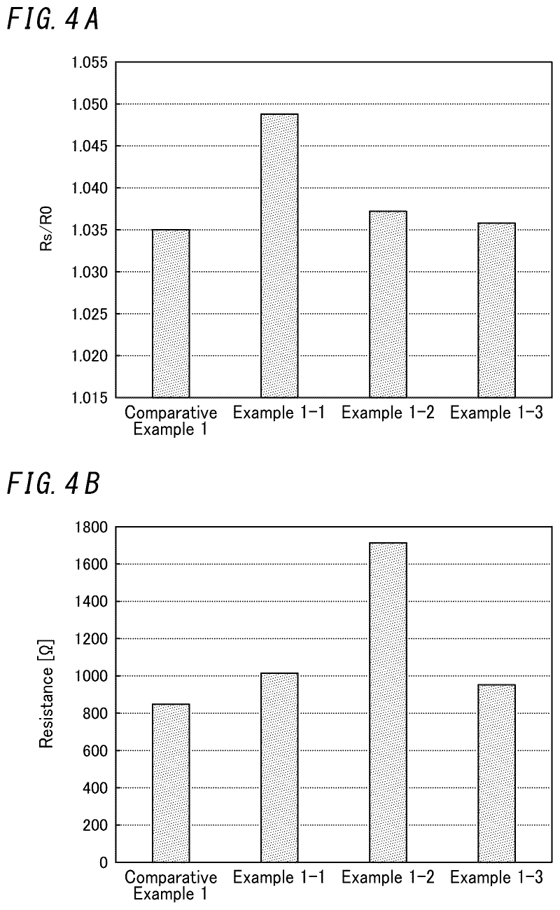

Each of the gas sensors of Comparative Example 1, Examples 1-1 to 1-3, Examples 2-1 to 2-4, Examples 3-1 to 3-4, and Examples 4-1 to 4-4 was evaluated in terms of sensor sensitivity. Specifically, nitrogen gas was supplied as a reference gas into the gas sensor for 30 seconds, and then benzaldehyde having a concentration of 10 ppm was supplied as a sample gas to be evaluated (evaluation gas) into the gas sensor for 30 seconds. This alternate supplies of the reference and sample gases were repeated six times. In this manner, the resistance value R0 when the reference gas was introduced and the resistance value Rs when the evaluation gas was introduced were measured. The average values of R0 and Rs thus measured were calculated, and the sensor sensitivity Rs/R0 was calculated based on these average values. A graph showing the Rs/R0 of the respective gas sensors in comparison is shown in FIG. 4A. On the other hand, a graph showing, in comparison, the resistance values Rs of the respective comparative examples and examples is shown in FIG. 4B.

As shown in FIG. 4A, in Comparative Example 1 in which the conductive particles were not covered with alkylsilane, Rs/R0 was about 1.035. On the other hand, in Examples 1-1 and 1-2 in which the conductive particles are covered with alkylsilane, Rs/R0 increased significantly compared to Comparative Example 1. In Example 1-1, in which the alkylsilane contained a compound having a methyl group, Rs/R0 increased particularly significantly. Likewise, in Example 1-3 in which the conductive particles were covered with phenylsilane, Rs/R0 also increased significantly compared to Comparative Example 1. Furthermore, as shown in FIG. 4B, in Example 1-2 in which the alkylsilane contained a compound having a propyl group, the resistance value increased more significantly than in any of Comparative Example 1, Example 1-1, and Example 1-3.

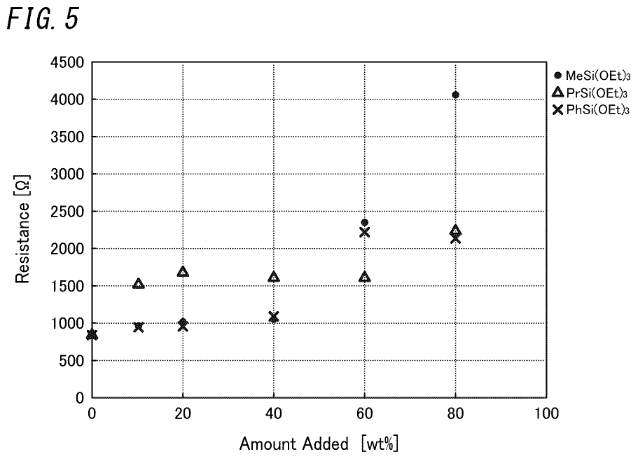

Furthermore, FIG. 5 is a graph showing, in comparison, the resistance values Rs in Comparative Examples 1 and 2 and Examples 1-1 to 4-4. FIG. 5 is a graph, of which the ordinate indicates the resistance value, and the abscissa indicates the amount of at least one of alkylsilane or arylsilane added to the conductive particles (indicated simply as “amount added” in the graph). That is to say, FIG. 5 is a graph showing how the resistance value changes according to the amount of the silane coupling agent added. As shown in FIG. 5, in each of methyltriethoxysilane, propyltriethoxysilane, and phenyltriethoxysilane, the resistance value tended to increase as the amount added increased.

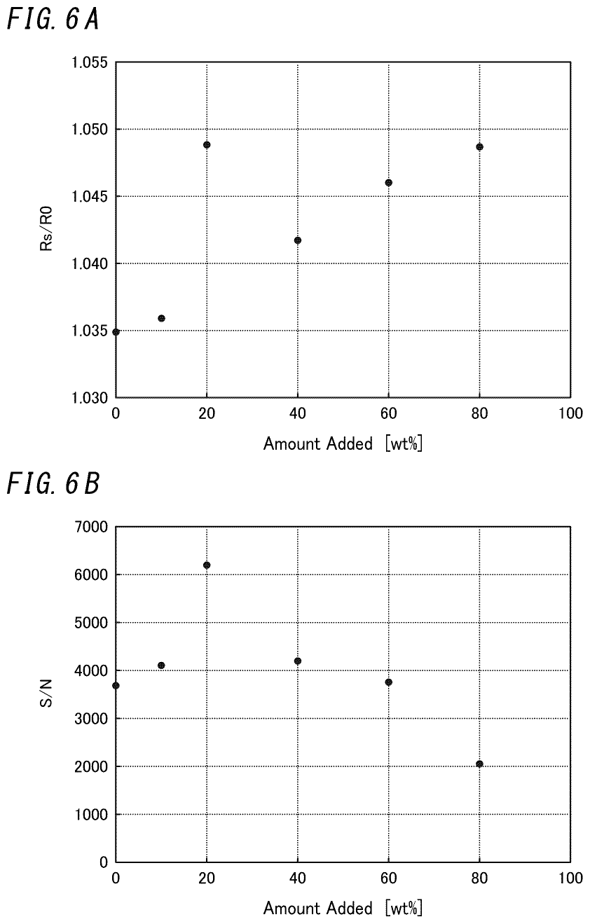

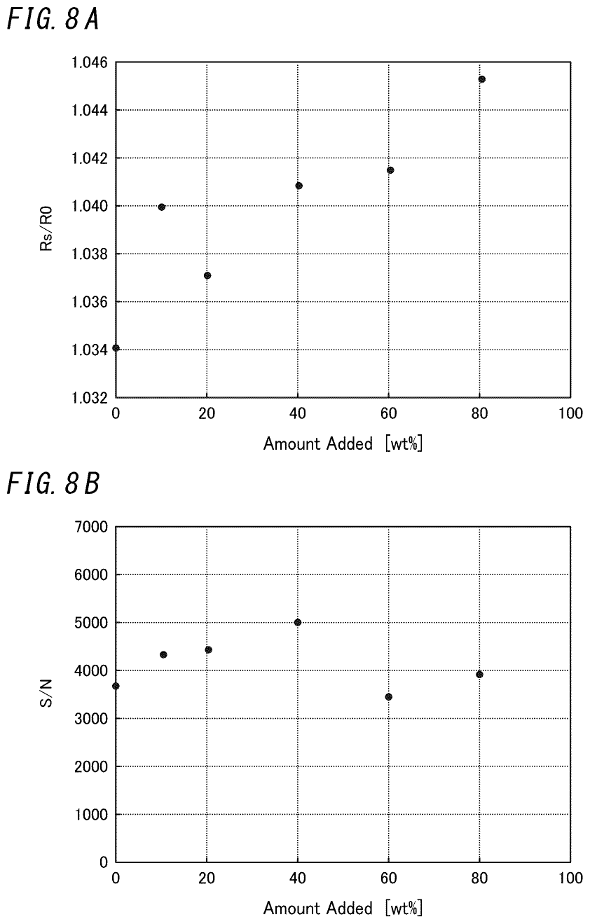

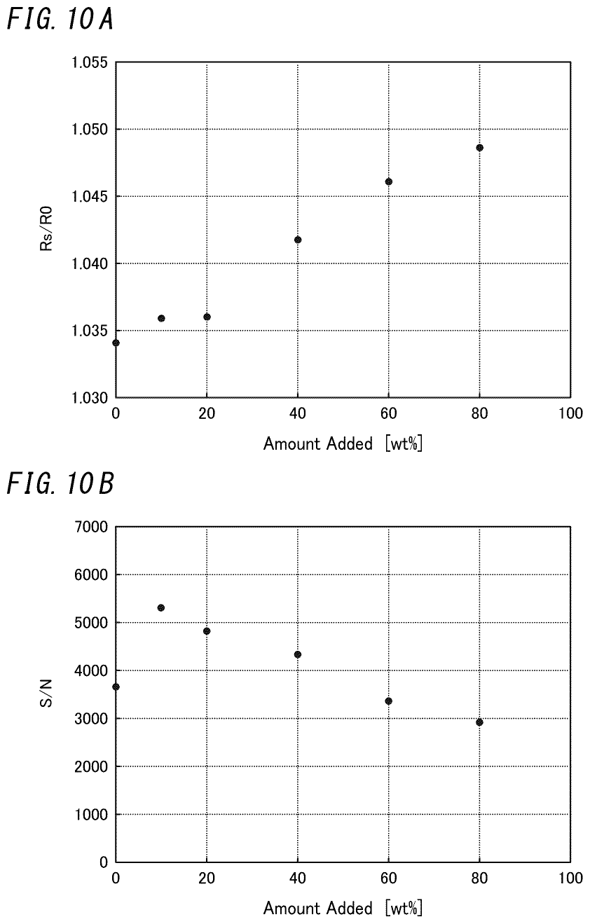

FIG. 6A is a graph, of which the ordinate indicates Rs/R0 in Comparative Example 1, Example 1-1, and Examples 2-1 to 2-4 and the abscissa indicates the amount of alkylsilane or arylsilane added to the carbon black (which is labeled simply as “amount added;” the same statement applies to the other drawings). Likewise, FIG. 8A is a graph, of which the ordinate indicates Rs/R0 in Comparative Example 1, Example 1-2, and Examples 3-1 to 3-4 and the abscissa indicates the amount added. FIG. 10A is a graph, of which the ordinate indicates Rs/R0 in Comparative Example 1, Example 1-3, and Examples 4-1 to 4-4 and the abscissa indicates the amount added.

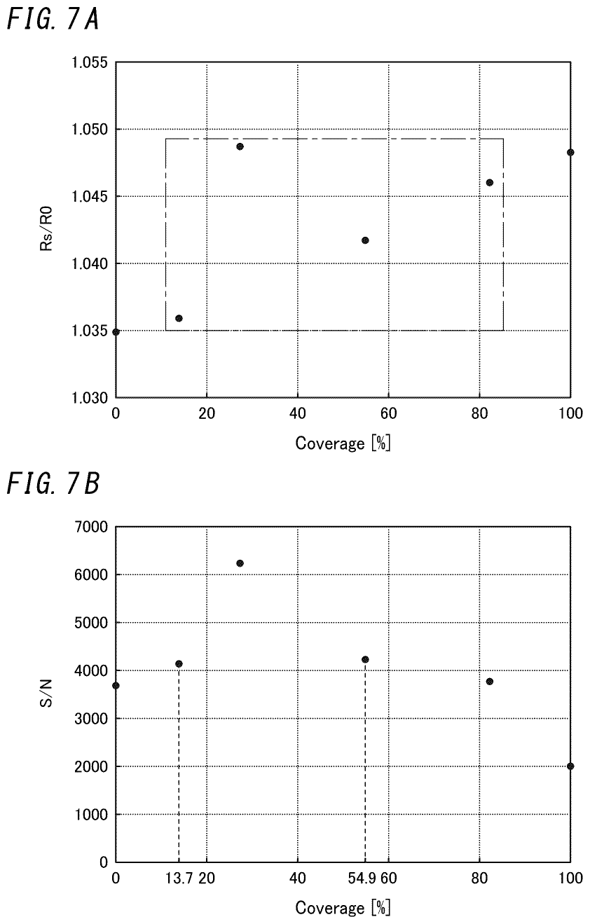

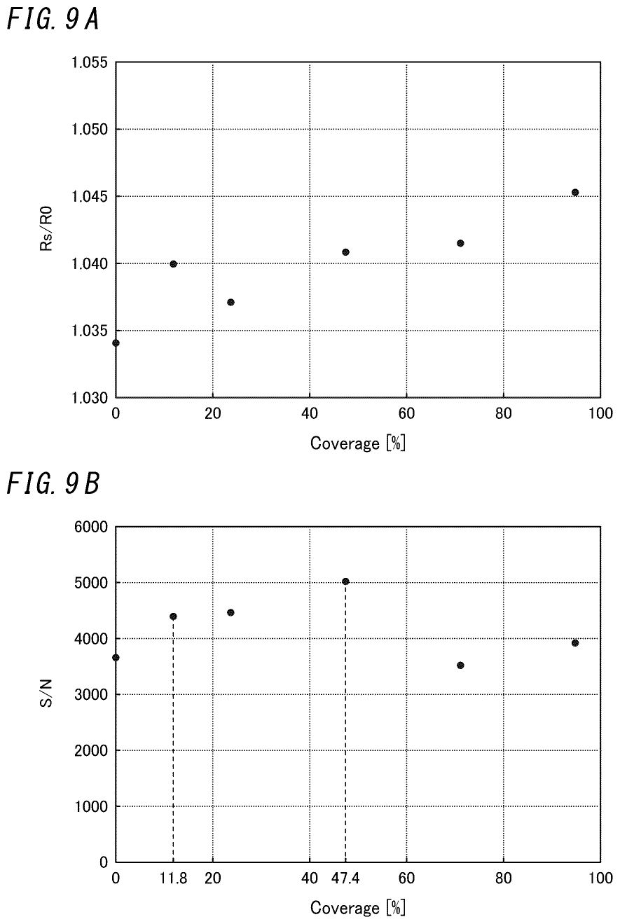

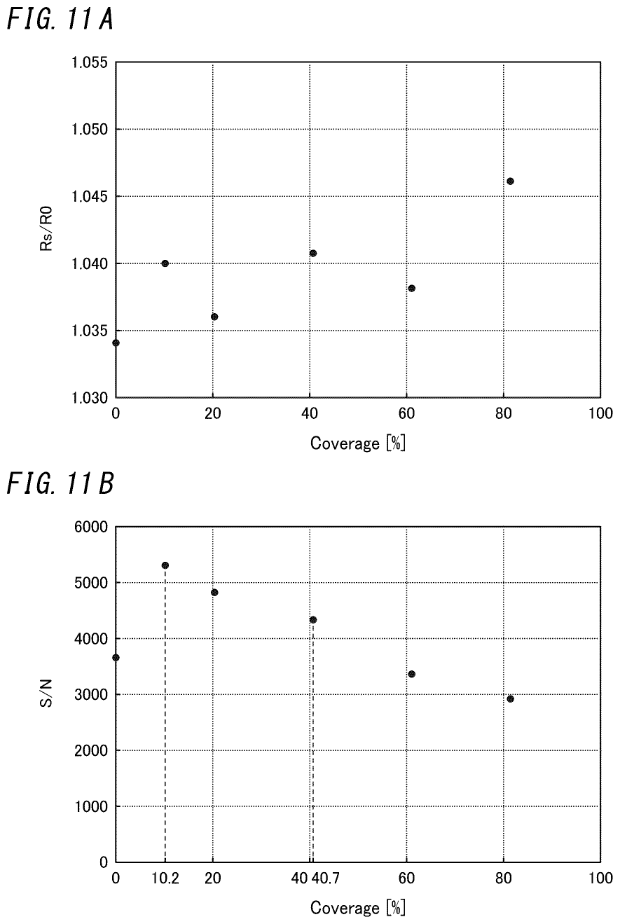

On the other hand, FIG. 7A is a graph, of which the ordinate indicates Rs/R0 in Comparative Example 1, Example 1-1, and Examples 2-1 to 2-4 and the abscissa indicates the surface coverage of the carbon black (which is labeled simply as “coverage;” the same statement applies to the other drawings). Likewise, FIG. 9A is a graph, of which the ordinate indicates Rs/R0 in Comparative Example 1, Example 1-2, and Examples 3-1 to 3-4 and the abscissa indicates the coverage. FIG. 11A is a graph, of which the ordinate indicates Rs/R0 in Comparative Example 1, Example 1-3, and Examples 4-1 to 4-4 and the abscissa indicates the coverage.

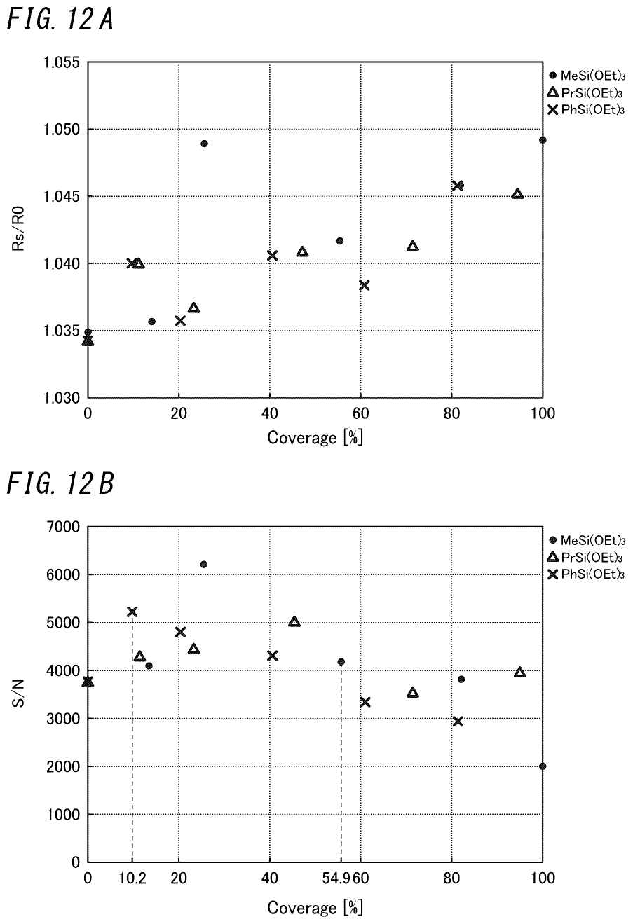

FIG. 12A is a graph showing how the sensitivity Rs/R0 changed according to the coverage for each type of silane coupling agent in Comparative Example 1 and Examples 1-1 through 4-4.

As shown in FIGS. 6A, 8A, and 10A, in Examples 1-1 to 4-4 containing conductive particles modified with either alkylsilane or arylsilane, of which the content is equal to or greater than 10% by weight with respect to the total weight of the conductive particles, the sensitivity improved more significantly than in Comparative Example 1. That is to say, in each of the examples, it was confirmed that sensitivity improved significantly compared to Comparative Example 1 when conductive particles modified with at least one of alkylsilane and arylsilane were used. Furthermore, when converted into coverage, the sensitivity was particularly high in a range where the coverage is equal to or greater than 10% as shown in FIGS. 7A, 9A, and 11A.

### 2.2. SNR

As for the gas sensors of Comparative Example 1, Examples 1-1 to 1-3, Examples 2-1 to 2-4, Examples 3-1 to 3-4, and Examples 4-1 to 4-4, the SNR of Rs/R0 was calculated based on the sensor sensitivity Rs/R0 and the standard deviation σ_{R0} of R0. The standard deviation σ_{R0} of R0 was calculated based on the resistance value R0 at a point in time when the 100^{th} sample was taken during a period from −0.1 seconds through 1.1 seconds on the supposition that 0 seconds was a point in time when a nitrogen gas was introduced as a reference gas into the gas sensor and started to flow in. With the value of Rs/R0 with respect to the standard deviation σ_{R0} in Comparative Example 1, Example 1-1, and Examples 2-1 to 2-4 defined to be the SNR (represented simply as “S/N” in the graph; the same statement will apply to the other drawings), FIG. 6B is a graph showing the relationship between the S/N as the ordinate and the amount added as the abscissa. Similarly, FIG. 8B is a graph, of which the ordinate indicates the S/N, and the abscissa indicates the amount added in Comparative Example 1, Example 1-2, and Examples 3-1 to 3-4. FIG. 10B is a graph, of which the ordinate indicates the S/N, and the abscissa indicates the amount added in Comparative Example 1, Example 1-3, and Examples 4-1 to 4-4.

On the other hand, FIG. 7B is a graph of which the ordinate indicates the S/N, and the abscissa indicates the coverage in Comparative Example 1, Example 1-1, and Examples 2-1 to 2-4. FIG. 9B is a graph of which the ordinate indicates the S/N, and the abscissa indicates the coverage in Comparative Example 1, Example 1-2, and Examples 3-1 to 3-4. FIG. 11B is a graph of which the ordinate indicates the S/N, and the abscissa indicates the coverage in Comparative Example 1, Example 1-3, and Examples 4-1 to 4-4.

FIG. 12B is a graph showing how the SNR changed according to the coverage for each type of silane coupling agent in Comparative Example 1 and Examples 1-1 through 4-4;

As shown in FIGS. 7B and 9B, when the conductive particles modified with at least one of methyltriethoxysilane as alkylsilane or propyltriethoxysilane as alkylsilane were contained, a higher SNR was achieved within the range in which the coverage fell within the range from 12% to 55%. Taking this result along with the results shown in the section 2.1 into consideration, it can be seen that setting the coverage of alkylsilane at a value equal to or higher than 12% and equal to or lower than 55% allows the sensitive membrane to have not only high sensor sensitivity but also an excellent SNR as well.

Likewise, as shown in FIG. 11B, when the conductive particles modified with phenyltriethoxysilane as arylsilane were contained, a higher SNR was achieved within the range in which the coverage fell within the range from 10% to 41%. Taking this result along with the results shown in the section 2.1 into consideration, it can be seen that setting the coverage of arylsilane at a value equal to or higher than 10% and equal to or lower than 41% allows the sensitive membrane to have not only high sensor sensitivity but also an excellent SNR as well. That is to say, adding the conductive particles modified with at least one of alkylsilane or arylsilane with the coverage falling within the particular range described above would not only improve the sensor sensitivity of the sensitive membrane but also increase the SNR as well compared to Comparative Example 1.

Furthermore, evaluation was made in the same way as in the sections 2.1 and 2.2 with the sample gas to be evaluated in each example changed from 10 ppm of benzaldehyde into 10 ppm of pyrrole. As a result, the same tendency was observed irrespective of the type of the evaluation gas. That is to say, it was confirmed that the sensitivity improved and the SNR increased as well.

### (Recapitulation)

As can be seen from the foregoing description, a sensitive membrane (20) according to a first aspect contains a sensitive material (201) and conductive particles (202). The sensitive material (201) adsorbs an analyte. The conductive particles (202) are modified with at least one of alkylsilane or arylsilane.

This aspect achieves the advantage of improving the sensitivity of the sensor.

In a sensitive membrane (20) according to a second aspect, which may be implemented in conjunction with the first aspect, the sensitive material (201) is expandable when adsorbing the analyte.

This aspect allows the sensitive membrane (20) to detect the analyte easily.

In a sensitive membrane (20) according to a third aspect, which may be implemented in conjunction with the first or second aspect, the alkylsilane contains a compound having an alkyl group, of which the carbon number is equal to or greater than one and equal to or less than three.

This aspect achieves the advantage of further improving the sensitivity of the sensor.

In a sensitive membrane (20) according to a fourth aspect, which may be implemented in conjunction with any one of the first to third aspects, the alkylsilane contains a compound having an alkoxy group.

This aspect achieves the advantage of improving the sensitivity of the sensor more significantly.

In a sensitive membrane (20) according to a fifth aspect, which may be implemented in conjunction with any one of the first to fourth aspects, the alkylsilane contains a compound having three alkoxy groups.

This aspect achieves the advantage of improving the sensitivity of the sensor even more significantly.

In a sensitive membrane (20) according to a sixth aspect, which may be implemented in conjunction with any one of the first to fifth aspects, the arylsilane contains a compound having three alkoxy groups.

This aspect achieves the advantage of improving the sensitivity of the sensor more significantly.

In a sensitive membrane (20) according to a seventh aspect, which may be implemented in conjunction with any one of the first to sixth aspects, the conductive particles (202) are covered with the alkylsilane at a coverage equal to or higher than 10%.

This aspect achieves the advantage of further improving the sensitivity of the sensor.

In a sensitive membrane (20) according to an eighth aspect, which may be implemented in conjunction with any one of the first to sixth aspects, the conductive particles (202) are covered with the arylsilane at a coverage equal to or higher than 10%.

This aspect achieves the advantage of further improving the sensitivity of the sensor.

In a sensitive membrane (20) according to a ninth aspect, which may be implemented in conjunction with any one of the first to eighth aspects, the conductive particles (202) are covered with the alkylsilane at a coverage equal to or higher than 12% and equal to or lower than 55%.

This aspect may further improve the sensitivity of the sensor and increase the SNR of the sensor sensitivity, thus achieving the advantage of making the analyte detectible with high sensitivity and good stability.

In a sensitive membrane (20) according to a tenth aspect, which may be implemented in conjunction with any one of the first to ninth aspects, the conductive particles (202) are covered with the arylsilane at a coverage equal to or higher than 10% and equal to or lower than 41%.

This aspect may further improve the sensitivity of the sensor and increase the SNR of the sensor sensitivity, thus achieving the advantage of making the analyte detectible with high sensitivity and good stability.

In a sensitive membrane (20) according to an eleventh aspect, which may be implemented in conjunction with any one of the first to tenth aspects, the conductive particles (202) contain a carbon black.

This aspect achieves the advantage of further improving the sensitivity of the sensor.

In a sensitive membrane (20) according to a twelfth aspect, which may be implemented in conjunction with any one of the first to eleventh aspects, the proportion of the alkylsilane to a total weight of the conductive particles (202) is equal to or greater than 10% by weight.

This aspect achieves the advantage of allowing an interfacial layer of the sensitive membrane (20) to contribute more heavily and thereby increasing the sensitivity of the sensor.

In a sensitive membrane (20) according to a thirteenth aspect, which may be implemented in conjunction with any one of the first to twelfth aspects, the proportion of the arylsilane to a total weight of the conductive particles (202) is equal to or greater than 10% by weight.

This aspect achieves the advantage of allowing an interfacial layer of the sensitive membrane (20) to contribute more heavily and thereby increasing the sensitivity of the sensor.

In a sensitive membrane (20) according to a fourteenth aspect, which may be implemented in conjunction with any one of the first to thirteenth aspects, the sensitive material (201) contains a compound having either or both of a polysiloxane structure and/or a polyethylene glycol structure.

This aspect achieves the advantage of imparting excellent heat resistance to the sensitive membrane (20).

A gas sensor (1) according to a fifteenth aspect includes the sensitive membrane (20) according to any one of the first to fourteenth aspects, and a pair of electrodes (21) electrically connected to the sensitive membrane (20).

This aspect achieves the advantage of providing a gas sensor (1) with high sensor sensitivity.

### REFERENCE SIGNS LIST

1 Gas Sensor
20 Sensitive Membrane
201 Sensitive Material
202 Conductive Particle
21 Electrode

1. A sensitive membrane containing:
a sensitive material that adsorbs an analyte; and
conductive particles modified with at least one of alkylsilane or arylsilane.

2. The sensitive membrane of claim 1, wherein
the sensitive material is expandable when adsorbing the analyte.

3. The sensitive membrane of claim 1, wherein
the alkylsilane contains a compound having an alkyl group, of which a carbon number is equal to or greater than one and equal to or less than three.

4. The sensitive membrane of claim 1, wherein
the alkylsilane contains a compound having an alkoxy group.

5. The sensitive membrane of claim 1, wherein
the alkylsilane contains a compound having three alkoxy groups.

6. The sensitive membrane of claim 1, wherein
the arylsilane contains a compound having three alkoxy groups.

7. The sensitive membrane of claim 1, wherein
the conductive particles are covered with the alkylsilane at a coverage equal to or higher than 10%.

8. The sensitive membrane of claim 1, wherein
the conductive particles are covered with the arylsilane at a coverage equal to or higher than 10%.

9. The sensitive membrane of claim 1, wherein
the conductive particles are covered with the alkylsilane at a coverage equal to or higher than 12% and equal to or lower than 55%.

10. The sensitive membrane of claim 1, wherein
the conductive particles are covered with the arylsilane at a coverage equal to or higher than 10% and equal to or lower than 41%.

11. The sensitive membrane of claim 1, wherein
the conductive particles contain a carbon black.

12. The sensitive membrane of claim 1, wherein
proportion of the alkylsilane to a total weight of the conductive particles is equal to or greater than 10% by weight.

13. The sensitive membrane of claim 1, wherein
proportion of the arylsilane to a total weight of the conductive particles is equal to or greater than 10% by weight.

14. The sensitive membrane of claim 1, wherein
the sensitive material contains a compound having either or both of a polysiloxane structure and/or a polyethylene glycol structure.

15. A gas sensor comprising:
the sensitive membrane of claim 1; and
a pair of electrodes electrically connected to the sensitive membrane.
